(19) United States
(12) Patent Application Publication
(10) Pub. No.: US 2007/0290401 A1
(43) Pub. Date: Dec. 20, 2007

(54) Process for making a composite structure

(76) Inventor: John E. Potter, Camarillo, CA (US)

Correspondence Address: LOUIS L. DACHS, 1794 PALISADES DRIVE, PACIFIC PALISADES, CA, 90272, US

(21) Appl. No.: 11/453,540

(22) Filed: Jun. 15, 2006

(51) Int. Cl. B29C 70/34

(52) U.S. Cl. 264/258

(57) ABSTRACT

The invention is a process for making a composite structure. In detail, the process includes the steps of: 1) laying up a plurality of sheets of fibrous material fully impregnated with a resin on a mold surface forming a lay-up; 2) forming a chamber about the lay-up; 3) drawing a vacuum from the chamber; 4) simultaneously with the step of drawing a vacuum from the chamber, providing a source of additional resin to the lay up, such that the additional resin is drawn throughout the lay-up; and 5) heating the lay-up until the resin is cured.

### BACKGROUND OF THE INVENTION

1. Field of the Invention

The invention relates to the field of processes for the manufacture of composite parts or structures and, in particular, to the field of processes for the manufacture of composite parts wherein resin is injected into a lay-up of fibrous materials positioned in a mold.

2. Description of Related Art

A typical method of manufacturing composite pads involves the steps of laying up structural filamentary material pre-impregnated (PREPREGS) with a resin in a mold, vacuum bagging the lay-up, drawing a vacuum from between the bag and mold such that the lay-up is compressed by atmospheric pressure against the mold while, and, finally, heating the resin impregnated filamentary material until the resin is cured. Typically, the resin content in pregregs is at around 32 to 38 percent by weight.

Another process is called vacuum assisted resin transfer molding (VARTM) that does not require such prepregs. These processes are similar in that structural filamentary material is still laid up in a mold, however it is resin free or has no more than 5 percent resin content. The lay up is vacuum bagged, a vacuum is drawn from between the bag and mold such that the lay-up is compressed by atmospheric against the mold. However, in this process, resin is simultaneously drawn in through an inlet port in the vacuum bag and through the lay-up impregnating it. Finally, the now impregnated filamentary material is heated until the resin is cured. Such a process is essentially disclosed in U.S. Pat. No. 2,913,036 “Process And Apparatus For Molding Large Plastic Structures” by G. H. Smith. Here the lay-up is placed over a mold. The lay-up itself incorporates a plurality of channels wherein resin can flow from the periphery of the lay-up upward to the center thereof. Thus after vacuum bagging, the resin is pumped into the lay-up from the periphery of the mold while a vacuum is pulled from a plurality of locations in the center.

This resin distribution problem was also addressed in U.S. Pat. No. 4,132,755 “Process For Manufacturing Resin Impregnated Reinforced Articles Without The Presence of Resin Fumes” by J. Johnson. This process includes the steps of placing the lay-up in a mold; placing a sheet of flexible material containing a plurality of dispersed perforations thereover and sealing its periphery to the mold so as to define a sealed inner chamber in which the lay-up is contained; placing a sheet of impervious flexible material (vacuum bag) over the sheet of perforated flexible material, with the periphery thereof also sealed to the mold so as to define a sealed outer chamber in which the inner chamber is contained, connecting the inner chamber to a vacuum source so as to draw the vacuum bag and perforated sheet, against the lay-up; and connecting the outer chamber to a source of resin so that the resin is passed from the outer chamber into the reinforcing material through the perforations of the first-mentioned sheet and into the lay-up.

In U.S. Pat. No. 4,902,215 “Plastic Transfer Molding Techniques For the Production of Fiber Reinforced Plastic Structures” By W. H. Seemann the apparatus includes a mold over which a fluid impervious outer sheet or vacuum bag, having a resin inlet port, that is marginally sealed to the mold forming a chamber in which the lay-up is placed for subsequent molding. A vacuum outlet port is provided for drawing a vacuum from the chamber. A resin distribution medium is positioned between the lay-up and vacuum bag. In one embodiment, the distribution medium is a sheet comprising an open network of non-swelling, non-resin absorbing intersecting monofilaments having pillar like members at the intersections. In a second embodiment, the distribution medium includes intersecting strips. In a third embodiment the distribution medium is a weaved or knitted plastic fabric. In addition, a distribution means or channel formed by incorporating a helical spring between the lay-up and vacuum bag extending from the resin inlet across the distribution medium, insures that the resin is evenly distributed. A vacuum is drawn via the outlet port and resin is drawn in through the inlet port.

Drawing of the vacuum causes the vacuum bag to collapse down on the lay-up and form the lay-up against the mold. However, the resin distribution medium insures that the resin is distributed evenly over the lay-up by keeping the vacuum bag from collapsing onto the lay-up. The inventor claims that due to its open pillar-like structure of the distribution medium and the continuous network of lateral openings lying between these pillars, a continuous network of passageways in all direction is provided from the point of entry of the resin, or fluid plastic, over the whole area of the distribution medium.

Thus it is a primary object of the subject invention to provide an process for making composite structures.

It is another primary object of the subject invention to provide process for making composite structures by the VARTM process with fully impregnated prepregs.

It is a further object of the subject invention to provide process for making composite structures using fully impregnated filamentary material that does not require the use of a resin distribution medium.

### SUMMARY OF THE INVENTION

The invention is a process for making a composite structure having first and second opposed surfaces. In detail, the process includes the following steps:

1. Laying up a plurality of sheets of fibrous material fully impregnated with a resin on a mold surface forming a lay-up. Thus the resin content is around the 32 to 38 percent by weight. The mold surface conforms to the first surface of the structure to be formed.
2. Forming a chamber about the lay-up. Typically, the second surface of the lay-up is first covered with a plurality of members that conform to the final shape of the structure to be formed. Thereafter a rigid cover is placed there over and sealed to the mold surface forming a chamber containing the members and lay-up and simultaneously forcing the members to compress the lay-up.

### 3. Drawing a vacuum from the chamber;

4. Providing a source of additional resin to the lay up, such that the additional resin is drawn throughout the lay-up. This requires that the resin be heated sufficiently to allow it to flow into the lay-up; but at a temperature below the typical curing temperature of the additional resin. This insures that all gaps or voids are filled with resin.

### 5. Heating the lay-up until the resin has cured.

The above process allows larger structures to be formed than provided by the typical VARTM methods because it is not limited to how far the resin will flow. Difficult to fill lay-ups for complicated structures are eliminated because air pockets or dry unfilled area cannot occur during the injection process. Fiber waviness cannot occur because the mold is already full prior to injecting the additional resin. Resins that are not typically used for VARTM, because of their viscosity, may be used in this process to provide a superior product.

The novel features which are believed to be characteristic of the invention, both as to its organization and method of operation, together with further objects and advantages thereof, will be better understood from the following description in connection with the accompanying drawings in which the presently preferred embodiment of the invention is illustrated by way of example. It is to be expressly understood, however, that the drawings are for purposes of illustration and description only and are not intended as a definition of the limits of the invention.

### BRIEF DESCRIPTION OF THE DRAWINGS

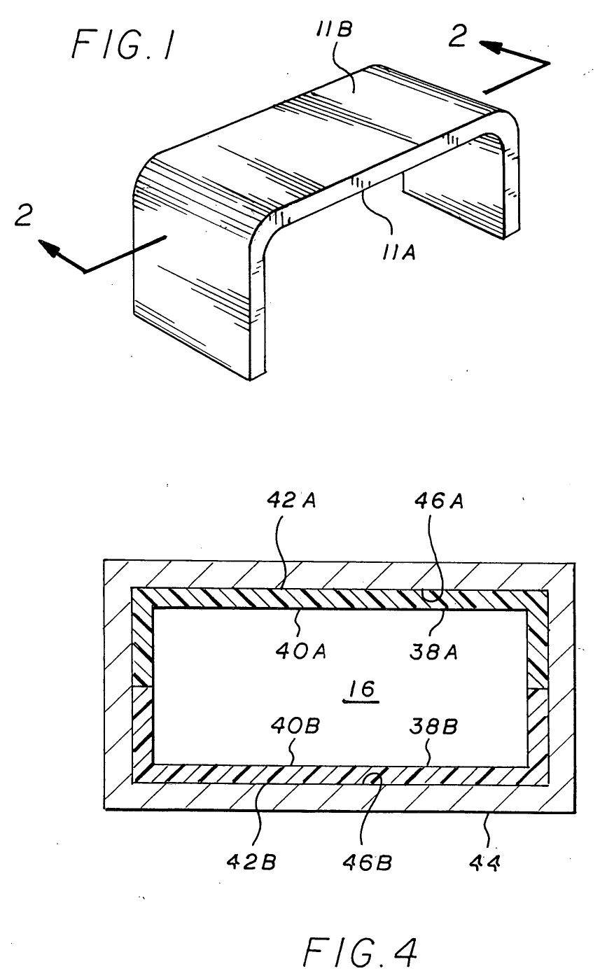

FIG. 1 is a perspective view of the completed structure formed by the subject process.

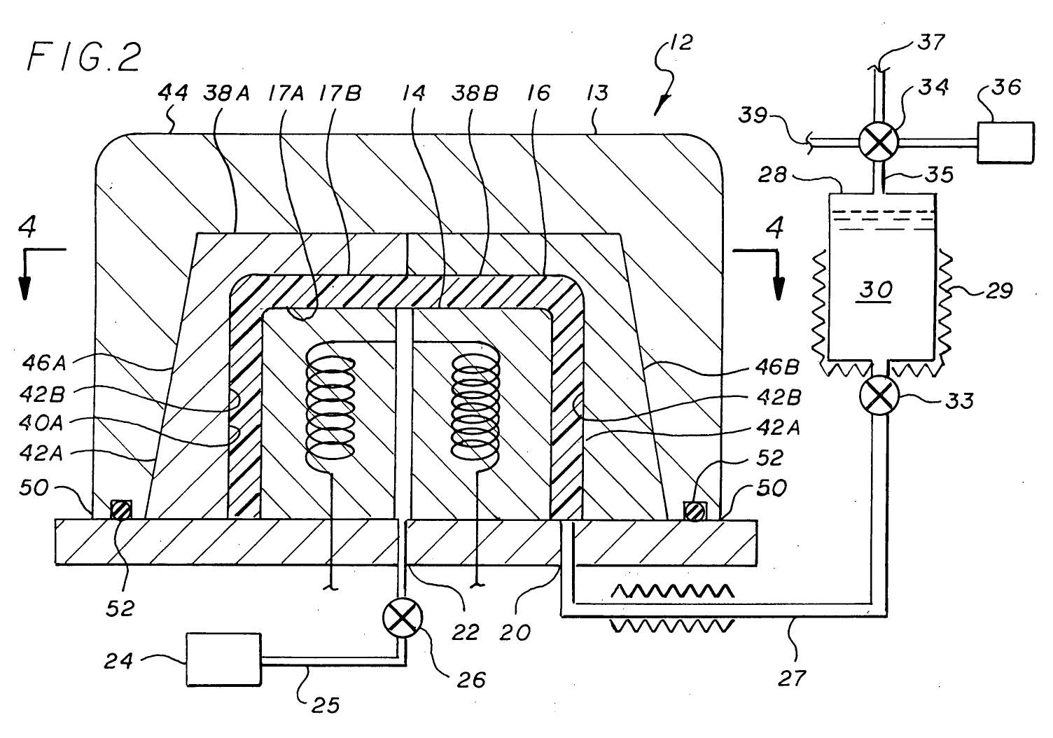

FIG. 2 is a cross-sectional view of the apparatus shown in FIG. 1.

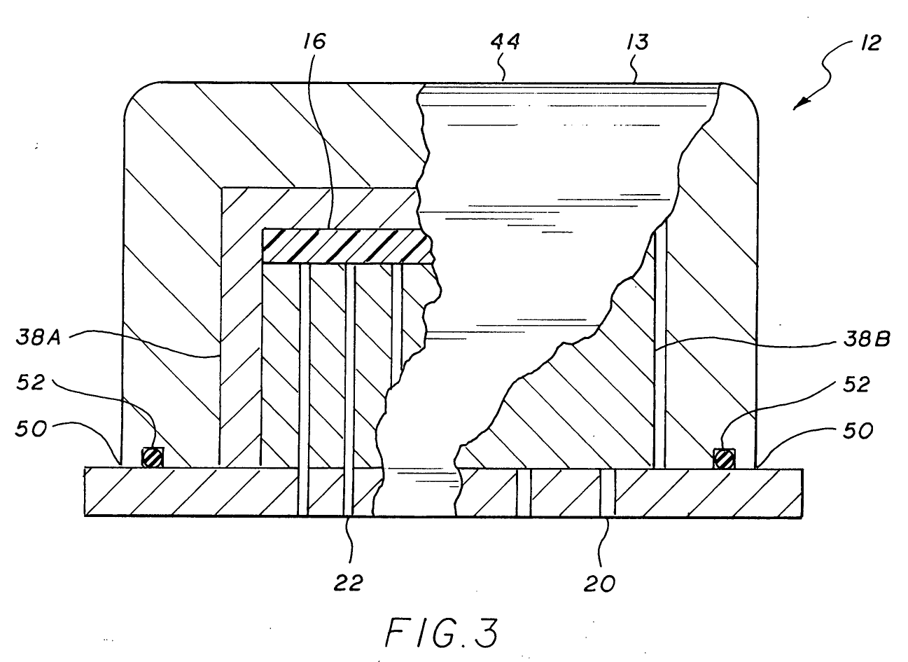

FIG. 3 is a partially broken away side view of the apparatus used in the process.

FIG. 4 is a cross-sectional view of the apparatus shown in FIG. 1 taken along the line 44.

### DESCRIPTION OF THE PREFERRED EMBODIMENT

FIG. 1 is a perspective view of a completed structure 10 having opposed principle surfaces 11A and 11B and is made of composite material containing filamentary material, either woven or unidirectional (with individual plies at various angles to each other) encased in a cured resin.

Still referring to FIG. 1 and additionally to FIGS. 2 and 3, the apparatus, generally indicated by numeral 12 is typical of those use in the subject process. It includes a mold 13, having a mold surface 14 having the contour of the surface 22A of the structure 10, to be formed. A lay-up 16, having first and second side 17A and 17B, made of individual layers of either woven or unitary fibrous material, or a combination of both, is laid up on the mold surface 14. The lay-up is fully impregnated with resin (about 32 to 38 percent by weight). Resin input ports 20 are provided in the mold 12 positioned so as to direct resin to the lay-up 16. Vacuum ports 22 on the mold surface 14 are coupled to a vacuum pumping system 24 via lines 25 having a valve 26 mounted therein. The resin inlet ports 20 are coupled to heatable line 27, which connects to a resin storage tank 28 having a heater 29 for heating resin 30 to a flowable state. A valve 33 is mounted in the line 27 to control resin flow. A valve 34 is mounted at the inlet port 35 of the resin tank 28, which can connect the tank to a vacuum pumping system 36, shop air 37 or directly to the atmosphere 39.

Once the lay-up 16, is placed on the mold surface 14, a pair of forming members 38A and 38B are positioned about the lay-up 16. The members 38A and 38B, having internal surfaces 40A and 40B conforming to the contour 11B of the structure 10. The external surfaces 42A and 42B are tapered. A housing 44 having internal tapered side walls 46A and 46B is positioned over the members 38A and 38B, such that tapered side walls 46A 45B contact surface 42A and 42B such that members are driven into contact with the lay-up 16 as the periphery 50 of the housing contacts the mold 11. A sealing member 52 in the periphery 50 seals of the chamber 54 thus formed.

Thus the process is a follows:

1. Laying up a up a plurality of sheets of fibrous material fully impregnated with a resin on a mold surface forming a lay-up. Thus the resin content is around the 32 to 38 percent by weight. The mold surface conforms to the first surface of the structure to be formed.
2. Forming a chamber about the lay-up. Typically, the second surface of the lay-up is first covered with a plurality of members that conform to the final shape of the structure to be formed. Thereafter a rigid cover is placed there over and sealed to the mold surface forming a chamber containing the members and lay-up and simultaneously forcing the members to compress the lay-up.

### 3. Drawing a vacuum from the chamber via vacuum ports 22 and pumping system 24;

4. Providing a source of additional resin to the lay up, the resin in the resin tank 28 is heated to the injection temperature with heater 29. Vacuum is then applied to the resin to remove entrapped air in the resin with vacuum pumping system 36 through the inlet port 35 and valve 34. While vacuum is applied valve 26 is opened to evacuate air from the lines leading to lay-up 16. After the system has been evacuated through the resin, the resin tank 28 is vented to atmosphere. Thereafter, air pressure 37 via valve 34 and inlet port 36 is then slowly applied to the resin tank pushing resin into the lay-up while vacuum draws resin throughout the lay-up through lines 22. This requires that the resin be heated sufficiently to allow it to flow into the lay-up; but at a temperature below the typical curing temperature of the additional resin. This insures that all gaps or voids are filled with resin.
5. Heating the lay-up until the resin has cured. Note that resin is applied under pressure until the resin has cured.

Any resin in the inlet ports 20 and vacuum ports 22 that has cured can be removed upon removal of the completed structure 10 from the apparatus 12.

While the invention has been described with reference to a particular embodiment, it should be understood that the embodiment is merely illustrative as there are numerous variations and modifications, which may be made by those skilled in the art. Thus, the invention is to be construed as being limited only by the spirit and scope of the appended claims.

### INDUSTRIAL APPLICABILITY

The invention has applicability to any industry requiring composite structures, such as the aircraft industry.

1. A process for making a composite structure having first and second opposed surfaces, the process comprising the steps of:
laying up a plurality of sheets of fibrous material fully impregnated with a resin on a mold surface forming a lay-up;
forming a chamber about the lay-up;
drawing a vacuum from the chamber;
providing a source of additional resin to the lay up, such that the additional resin is drawn throughout the lay-up; and
heating the lay-up until the resin is cured.

2. The process as set forth in claim 1 including the step of heating the additional resin to a temperature wherein it is flowable into the lay-up.

3. The process as set forth in claim 2 wherein prior to the step of heating the lay-up until the resin has cured, terminating the source of additional resin to the lay up.

4. The process as set forth in claim 3 wherein structure has to first and second opposed surfaces and the mold surface conforms to the first opposed surface, the step of forming a chamber about the lay-up includes the steps of:
covering the second opposed surface of the lay-up with a plurality of members that conform to the final shape of the structure to be formed; and
placing a chamber over the members causing the members to contact and compress the lay-up.
